(19) United States
(12) Patent Application Publication
(10) Pub. No.: US 2014/0121788 A1
(43) Pub. Date: May 1, 2014

(54) COMMUNICATION INTERFACE MODULE FOR AN AUTOMATION SYSTEM

(71) Applicant: ABB AG, Mannheim (DE)

(72) Inventors: Stefan GUTERMUTH, Lorsch (DE); Gernot Gaub, Hockenheim (DE)

(73) Assignee: ABB AG, Mannheim (DE)

(21) Appl. No.: 14/147,959

(22) Filed: Jan. 6, 2014

Related U.S. Application Data
(63) Continuation of application No. PCT/EP2012/002823, filed on Jul. 5, 2012.

(30) Foreign Application Priority Data
Jul. 6, 2011 (DE) 10 2011 107 322.5

(51) Int. Cl. G05B 19/05

(52) U.S. Cl. CPC G05B 19/054
USPC 700/19

(57) ABSTRACT

A communication interface module for an automation or control system for coupling at least two field bus systems is disclosed, the communication interface module includes at least one first functional unit configured to connect to a superordinate controller via a first communications link based on a first field bus protocol, at least one second functional unit configured to connect field devices via a second communications link based on a second field bus protocol, at least one serial interface configured to communicate with devices connected to the communication interface module, and at least one third functional unit configured to connect further field devices.

### RELATED APPLICATION(S)

This application claims priority as a continuation application under 35 U.S.C. §120 to PCT/EP2012/002823, which was filed as an International Application on Jul. 5, 2012, designating the U.S., and which claims priority to German Application No. 10 2011 107 322.5 filed on Jul. 6, 2011. The entire content of these applications are hereby incorporated by reference in their entireties.

### FIELD

The disclosure relates to a communication interface module or a gateway device, for connecting field devices to a superordinate controller via a bus system and for example, for coupling at least two field bus systems.

### BACKGROUND INFORMATION

Automation systems for controlling a technical process or a technical installation can include a central control unit. The central control unit can communicate with the input/output units and/or field devices of the automation system via a communication interface module, also called a gateway device. For example, the gateway device can be used for field buses of different protocols, for example FOUNDATION field bus and Profibus, to communicate.

The field devices and the central control unit can be connected via the input/output units. U.S. Pat. No. 6, 016,523 A shows such an input/output unit.

The gateway devices used in automation or control systems can be connected to the superordinate controller via a first bus and communicate with the field devices via a second bus.

DE 199 25 547 A1 describes a guide/control system having a mainframe computer, a bus and a multiplicity of input units and/or output units and/or input/output units and/or sensors and/or actuators, also called field devices below, the field devices being connected to the bus of the guide/control system via “intelligent” field bus plugs. For example, the field bus plugs can each be connected to the associated field devices via first plug-in apparatuses. Each field bus plug can be provided with a second plug-in apparatus and a connecting cable. The connecting cable of the field device engages in a second plug-in apparatus of a further field device via the plug at its end. A field device can engage in a further plug-in apparatus of a bus coupling means, thus establishing the connection to the bus and to the mainframe computer of the bus. In each field bus plug, the connecting contacts of its second plug-in apparatus can be internally connected to the corresponding lines of the connecting cable, thus ensuring the continuous connection between the field devices and the bus and the mainframe computer.

For a junction (gateway) and data interchange between different bus systems, the internal connecting contacts for the connection between the different buses can be effected in each field bus plug by means of complicated wiring.

Since each field device uses its own field bus plug for connecting the field devices to a high-quality or powerful bus, such as high-speed Ethernet or Profibus, the implementation of the field bus applications is cost-intensive, for example, when the functionality of the connected field device does not necessarily use direct connection to the powerful bus, for example, data interchange between the device and the superordinate control system is not needed.

### SUMMARY

A communication interface module for an automation or control system for coupling at least two field bus systems is disclosed, the communication interface module comprising: at least one first functional unit configured to connect to a superordinate controller via a first communications link based on a first field bus protocol; at least one second functional unit configured to connect field devices via a second communications link based on a second field bus protocol; at least one serial interface configured to communicate with devices connected to the communication interface module; and at least one third functional unit configured to connect further field devices.

### BRIEF DESCRIPTION OF THE DRAWINGS

The disclosure is explained below with reference to the exemplary embodiments, shown in the drawing. In the drawing:

FIG. 1 shows an exemplary structure of an automation system having the apparatus according to the disclosure for connecting a multiplicity of field devices to a superordinate control unit.

### DETAILED DESCRIPTION

In accordance with an exemplary embodiment, a communication interface module for an automation or control system is disclosed, wherein the field bus applications can be more cost-effective and the effort needed to connect the field devices is reduced, for example.

In accordance with an exemplary embodiment, a communication interface module for an automation or control system for coupling at least two field bus systems is disclosed, the communication interface module having at least one first functional unit for connection to a superordinate controller via a first communications link based on a first field bus protocol, and having at least one second functional unit for connecting field devices via a second communications link based on a second field bus protocol, wherein the module has at least one serial interface for communicating with devices connected to the communication interface module, and the module has at least one third functional unit which is intended to connect further field devices.

In accordance with an exemplary embodiment, the communication interface module according to the disclosure can be used in automation or control systems of process automation or machine control.

In accordance with an exemplary embodiment, for communication between field bus systems which process different protocols, the communication interface module according to the disclosure can include at least one first functional unit, which can enable connection to a superordinate controller, for example, a programmable logic controller, via a first communications link based on a first field bus protocol, and at least one second functional unit which can connect field devices via a second communications link based on a second field bus protocol.

In accordance with an exemplary embodiment, devices connected to the communication interface module can communicate using at least one serial interface integrated in the communication interface module.

The serial interfaces, can be, for example, in the form of RS232, /RS422 and/or RS485 interfaces and may have the same or different designs.

In accordance with an exemplary embodiment, the freely configurable serial interfaces can be provided for the purpose of transmitting different protocols, for example Modbus, CS31 bus, RCOM, RCOM+, COMLI, EPVS, SysLibCom and/or Multi, for example, changeover between two different protocols, for example Modbus, ASCII, SysLibCom.

In accordance with an exemplary embodiment, the communication interface module can have at least one third functional unit having input and/or output functionalities to which further field devices can be connected. The input/output functionalities may be input units, output units or else input and output functionalities.

In an exemplary embodiment, the communication interface module can communicate with the superordinate controller via the Profinet field bus protocol using the first communications link and communicates with the field devices via the CAN or CANopen field bus protocol using the second communications link.

The communication interface module can communicate between the field devices connected thereto and the superordinate control system using the first high-performance communications link in the form of a master connection, and can undertake communication between the field devices connected to the second bus via the second communications link which is integrated in the communication interface module and can be in the form of a slave connection, the master and slave connections for interchanging data between the field devices via the bus system being implemented using special software and/or hardware modules. For example, this means that the communication module can include a slave function in the primary communication system (for example Profinet) and a master function in the secondary communication system (for example CANopen).

The communication interface module according to the disclosure can have the input/output expansion provided with an interface in order to expand it with digital and/or analog input and/or output devices. For example, up to 320 digital channels or 160 analog channels or a mixture of accordingly reduced digital and analog channels can be provided.

The module according to the disclosure can reduce the device costs of the automation or control system since the input units, output units or else input and output units which can be in the form of separate devices, which can be saved by implementing their functions in the communication interface module according to the disclosure and the field devices can therefore be directly connected to the gateway device without an additional bus.

In accordance with an exemplary embodiment, the disclosure can enable a modular configuration, for example, the number of inputs and/or outputs, use as digital or analog inputs and/or outputs and the stipulation of their setting parameters via the existing communications links.

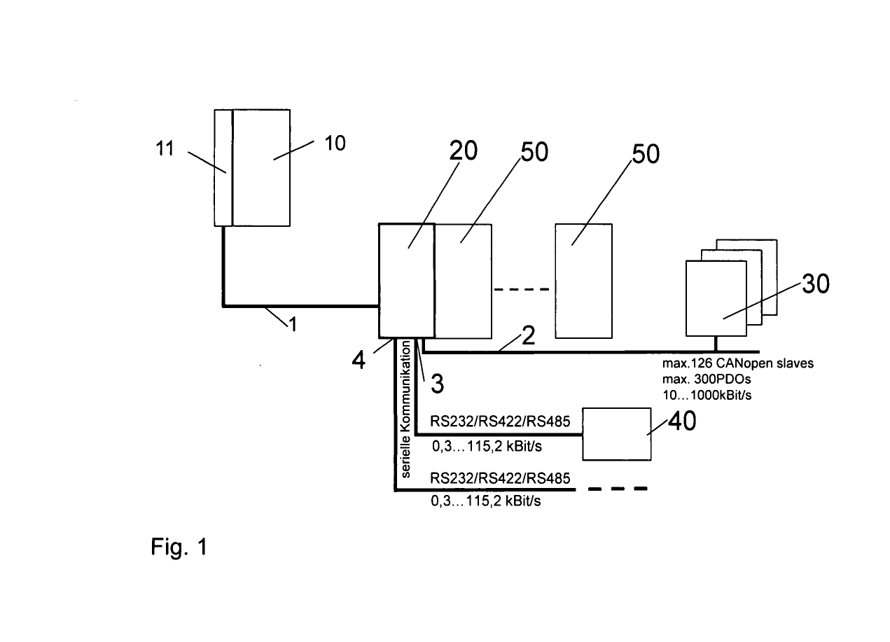

The exemplary implementation of a gateway device 20 between at least two different field bus systems 1, 2, as illustrated in FIG. 1, can include a control unit 10 in the form of a programmable logic controller. The central control unit 10 can be connected to the field devices 30, 40 via the gateway device 20 using its communication module 11. For example, the gateway device can include field buses 1, 2 of different protocols, for example Profinet and CAN or CANopen, to communicate.

The gateway device 20 can include a first functional unit, which handles communication with the control unit 10 via the Profinet field bus protocol 1, and a second functional unit or interface for communicating with CAN-compatible or CANopen-compatible devices 30 connected thereto via the CAN or CANopen field bus protocol.

Serial communication, via a serial bus, with devices 40 connected thereto can be carried out using two configurable, DC-isolated serial interfaces 3, 4, which can be independent of one another, can be integrated in the gateway device 20 and can be in the form of an RS232, /RS422 and/or RS485 interface, for example.

Input and/or output devices or further field devices 50 can also be connected to a third functional unit, which can be integrated in the gateway device 20.

The gateway device 20 according to the disclosure can be provided with digital input/output functionalities, with the result that up to 10 expansion modules 50 can be connected thereto. However, analog and digital input/output functionalities can also be mixed without any problems.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A communication interface module for an automation or control system for coupling at least two field bus systems, the communication interface module comprising:
at least one first functional unit configured to connect to a superordinate controller via a first communications link based on a first field bus protocol;
at least one second functional unit configured to connect field devices via a second communications link based on a second field bus protocol;
at least one serial interface configured to communicate with devices connected to the communication interface module; and
at least one third functional unit configured to connect further field devices.

2. The communication interface module as claimed in claim 1, wherein the at least serial interface is in the form of an RS232, /RS422 and/or RS485 interface.

3. The communication interface module as claimed in claim 1, wherein the communication interface module is configured to communicate with the superordinate controller via a Profinet field bus protocol.

4. The communication interface module as claimed in claim 1, wherein the communication interface module is configured to communicate with the field devices via a CAN or CANopen field bus protocol.

5. The communication interface module as claimed in claim 1, comprising:
two serial interfaces for serial communication with devices connected to the communication interface module; and
a further interface for communicating with CAN-compatible or CANopen-compatible devices connected thereto via a CAN or CANopen field bus protocol.

6. The communication interface module as claimed in claim 1, comprising:
an interface in order to expand the communication interface module with digital and/or analog input and/or output devices.

7. The communication interface module as claimed in claim 1, wherein the interface module is configured to be used in automation or control systems of process automation or machine control.
